(19) United States
(12) Patent Application Publication
(10) Pub. No.: US 2008/0136710 A1
(43) Pub. Date: Jun. 12, 2008

(54) Apparatus including antennas providing suppression of mutual coupling between current-carrying elements and methods for forming same

(75) Inventors: Igor S. Nefedov, Espoo (FI); Tomi Mynttinen, Helsinki (FI); Xu Liangge, Espoo (FI); Sergei A. Tretyakov, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/635,110

(22) Filed: Dec. 7, 2006

(51) Int. Cl. H01Q 1/38

(52) U.S. Cl. 343/700 MS

(57) ABSTRACT

An apparatus includes a number of electrically conductive spaced apart elements, and a ground plane situated at least partially in a space between at least two of the electrically conductive spaced apart elements. The apparatus further includes one or more wire media situated over at least a portion of and coupled to the ground plane, the one or more wire media situated at least partially in the space between the at least two electrically conductive spaced apart elements. Radiating elements may be used as the electrically conductive spaced apart elements to create an antenna. Such an antenna and apparatus may also include a conductive mesh, connecting tips of the pins (also called “wires”) of the wire medium. The wire medium and the conductive mesh can reduce coupling between the electrically conductive spaced apart elements (e.g., radiating elements). The apparatus can be formed at least in part in a semiconductor.

### TECHNICAL FIELD

This invention relates generally to apparatus that use current-carrying elements such as antennas and transmission lines and, more specifically, relates to techniques for suppressing mutual coupling between the current-carrying elements.

### BACKGROUND

The wire medium as an artificial electromagnetic material has been known for a long time. For instance, see J. Brown, Progress in Dielectrics 2, 195 (1960). A wire medium is formed, e.g., by a lattice of conducting parallel thin wires, where the wires are separated by a lattice period. Typically, the wires (also called “pins”) are placed into some type of insulating slab, such a dielectric or polystyrene foam. At low frequencies, the wire medium can be described in terms of effective medium parameters, and the permittivity of the wire medium is negative below the plasma frequency. The plasma frequency is determined by the ratio of the wire radius to the lattice period. Hence waves, having an electric field component parallel to the wires, attenuate in the wire medium slab. However, a wire medium slab over a metal ground plane can support propagation of surface waves with the other polarization (e.g., an electric field component perpendicular to the wires), as an impedance surface. See, e.g., R. J. King, The Synthesis of Surface Reactance Using an Artificial Dielectric, IEEE Trans. on Antennas and Propagation, vol. AP-31, No. 3, 471-476 (May 1983).

An antenna that has been known for a while is called a patch antenna. In a patch antenna, there is some flat, conductive shape (called a patch) above an insulating substrate, which is itself above a ground plane. See, e.g., C. Balanis, Antenna Theory: Analysis and Design, 3rd Edition, N.Y., John Wiley, 2005. Generally, the patch is rectangular, but other shapes may be used.

Since patch antennas are often used in arrays, their performance can be improved by suppression of mutual coupling by using wire media. Further, performance of any apparatus using current-carrying elements having mutual coupling may also be improved by using wire media.

### BRIEF SUMMARY

In an exemplary embodiment of the invention, an apparatus includes a number of electrically conductive spaced apart elements, and a ground plane situated at least partially in a space between at least two of the electrically conductive spaced apart elements. The apparatus further includes one or more wire media situated over at least a portion of the ground plane and coupled to the ground plane, the one or more wire media situated at least partially in the space between the at least two electrically conductive spaced apart elements.

In another exemplary embodiment, an apparatus includes an antenna and a transceiver. The antenna includes a ground plane and a number of spaced apart radiating elements, where each of the radiating elements has a portion that is approximately parallel to and situated above the ground plane. The antenna also includes one or more connectors having a ground portion coupled to the ground plane and a signal portion coupled to the radiating elements. The antenna further includes one or more wire media situated over and coupled to the ground plane, the one or more wire media situated at least partially in a space between at least two of the radiating elements. The transceiver is coupled to the one or more connectors and is configured to transmit or receive using the antenna.

In another exemplary embodiment, an antenna includes a ground plane and a first patch element having an edge and including a portion that is approximately parallel to the ground plane. The antenna also includes a first insulating substrate positioned between the portion of the first radiating element and the ground plane and a second patch element having an edge and including a portion that is approximately parallel to the ground plane. The first and second patch elements are separated by an area and the area is partially bounded by the edges of the first and second patch elements. The antenna further includes a second insulating substrate positioned between the portion of the second radiating element and the ground plane and one or more connectors having a ground portion coupled to the ground plane and a signal portion coupled to the first and second radiating elements. The antenna additionally includes a wire medium coupled to the ground plane and formed in a third insulating substrate, the third insulating substrate and wire medium situated at least partially in the area between the edges of the first and second patch elements. The antenna also includes a conductive mesh coupled to at least a portion of the wire medium and situated at least partially in the area between the edges of the first and second patch elements.

In yet another exemplary embodiment, a method includes spacing apart a plurality of elements, each of the elements configured to carry current, and situating a ground plane at least partially in a space between at least two of the spaced apart elements. The method further includes situating at least one wire medium over at least a portion of the ground plane, the at least one wire medium situated at least partially in the space between the at least two spaced apart elements, and coupling the at least one wire medium to the ground plane.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is a block diagram of an exemplary wireless network containing an antenna disclosed herein;

FIG. 2 is a top view of an exemplary antenna having two patch elements and a wire medium placed between the patch elements;

FIG. 3 is a cross-sectional view shown along cross-section 3-3′ in FIG. 2;

FIG. 4 is a graph of S-parameters of TM (transverse magnetic) excitation for an antenna with two patch elements and either not having a wire medium placed between the patch elements or having a wire medium placed between the patch elements (as shown in FIGS. 2 and 3);

FIG. 5 is an illustration of TE (transverse electric) excitation for an antenna with two patch elements and a wire medium placed between the patch elements (as shown in FIGS. 2 and 3);

FIG. 6 is a graph of S-parameters of a TE excitation for an antenna with two patch elements and either not having a wire medium placed between the patch elements or having a wire medium placed between the patch elements (as shown in FIGS. 2 and 3);

FIG. 7 is a top view of an exemplary antenna having two patch elements and a wire medium with a conductive mesh placed between the patch elements;

FIG. 8 is a cross-sectional view shown along cross-section 8-8′ in FIG. 7;

FIG. 9 is a graph of S-parameters of a TE excitation for an antenna with two patch elements and either not having a wire medium or having a wire medium and a conductive mesh placed between the patch elements (as shown in FIGS. 7 and 8);

FIG. 10 is a flowchart of an exemplary method of making and using the antennas shown in FIGS. 2, 3, 7, and 8;

FIGS. 11 and 12 are examples of pins from a wire medium, where the pins are capacitively coupled to the ground plane;

FIG. 13 is a top view of an exemplary apparatus having two current-carrying elements and a wire medium placed between the elements;

FIG. 14 is a cross-sectional view shown along cross-section 14-14′ in FIG. 13; and

FIG. 15 is a top view of an exemplary antenna having four patch elements and one to four wire media with associated conductor mesh placed between the patch elements.

### DETAILED DESCRIPTION OF EXEMPLARY EMBODIMENTS

As described above, a wire medium over a metal ground plane can support propagation of surface waves with both TM (transverse magnetic) and TE (transverse electric) polarizations. This is probably the reason why such structures were not proposed for coupling reduction in the past. The inventors have realized that a wire medium and associated insulating substrate can be used for coupling reduction when the wire medium is placed between two radiating elements of an antenna. Additional reduction is also realized when a wire (e.g., conductive) mesh is coupled to the wire medium.

The problem of reduction of mutual coupling between radiating elements in antenna arrays remains very important despite much effort spent in the past for its solution. Conventional solutions to this problem include the use of an electromagnetic band gap (EBG) ground plane (also called photonic band gap (PBG)). Utilization of electromagnetic band gap (EBG) structures is considered now as one of the most promising techniques for decoupling antenna radiating elements. Many different EBG structures were proposed and studied, see, e.g., D. Sievenpiper, “High-impedance electromagnetic surfaces”, Doctoral Thesis, University of California Los Angeles (UCLA), 1999; P. de Maagt, R. Gonzalo, J. Vardaxoglou, J.-M. Baracco, “Review of Electromagnetic Bandgap Technology and Applications”, The URSI Radio Science Bulletin, No. 309, 11-25 (June 2004); D. Sievenpiper, L. Zhang, R. F Jimenez Broaz, N. G. Alexpolous, E. Yablonovich, “High Impedance Electromagnetic Surfaces with a Forbidden Frequency Band”, IEEE Transactions on Microwave Theory and Techniques, Vol. 47, No. 11, 2059-2074 (November 1999); and F. Yang, Y. Rahmat-Samii, “Microstrip Antennas Integrated with Electromagnetic Band-Gap (EBG) Structures: A low Mutual Coupling Design for Array Applications”, IEEE Transactions on Antennas and Propagation, Vol. 51, No. 10, 2936-2946.(October 2003). Typically, these solutions utilize periodically arranged resonant metal elements that form a stop band in a certain frequency range. For example, different modifications of the conventional Jerusalem-cross EBG structure are used. Usually these structures also have complex designs, allow one to suppress only certain kinds of waves capable of propagating between antennas elements, and do not operate in wide frequency ranges due to their resonant nature. Furthermore, the known structures are not compact, since the period of the structure must be comparable to the wavelength.

Wire media, proposed herein as decoupling elements, effectively suppress TM polarization modes, but if no special measures are taken, increase the coupling in the case of the TE polarization, where the coupling is quite small even without an EBG structure. One embodiment of the disclosed invention overcomes the problem of TE surface mode excitation as well as creating a wide frequency band and relatively simple decoupling device. Embodiments of the invention therefore offer new structures for reducing mutual coupling between radiating elements of antenna arrays, for example patch antenna arrays of base stations. Thus, the structures herein reduce mutual coupling for one or both of TM and TE polarizations. The structures can be used in multi-element dual-polarized antennas, for example, in base station antenna arrays. The structures are based on a wire medium placed between radiating elements of an antenna and may further be based on a wire medium and a conductive mesh, connected to tips (tops) of the wires in the wire medium, placed between radiating elements of an antenna.

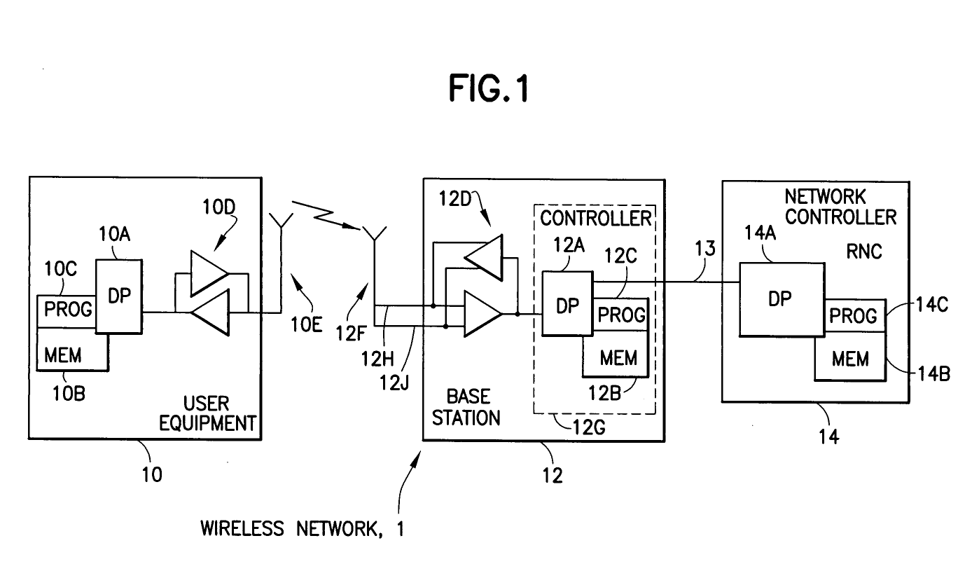

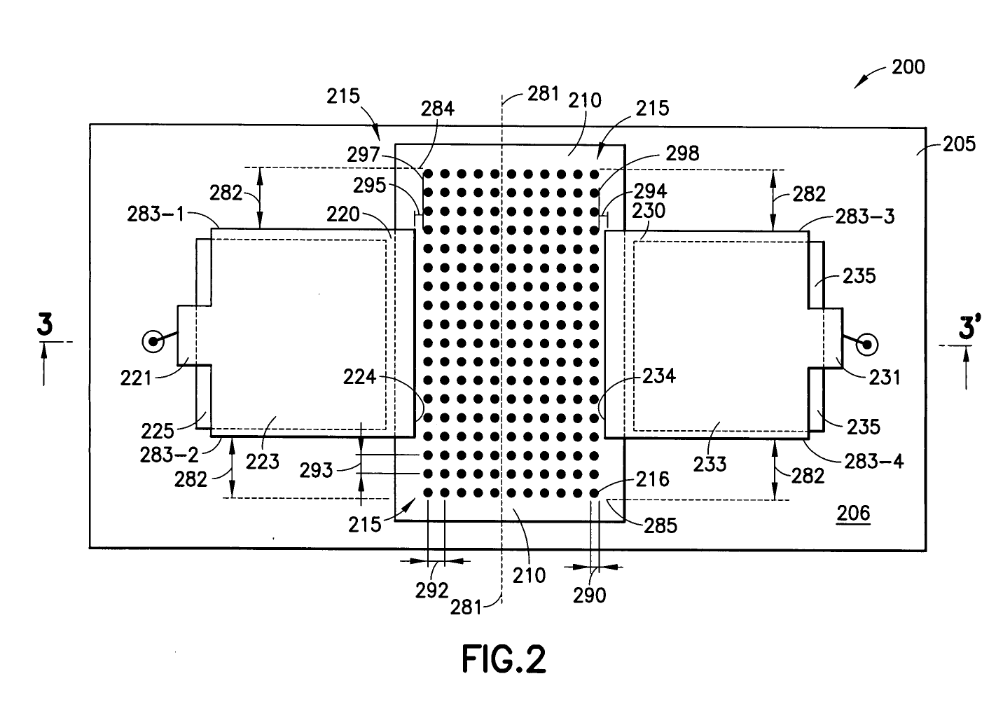

Reference is made first to FIG. 1 for illustrating a simplified block diagram of a wireless network 1 into which the exemplary antennas disclosed herein may be used. In FIG. 1, a wireless network 1 is adapted for bidirectional communication with a user equipment 10 via a base station 12 (e.g., a Node B, base transceiver station). Also shown is an exemplary network controller 14 (e.g., an RNC, base station controller) of the wireless network 1. The user equipment 10 includes a data processor (DP) 10A, a memory (MEM) 10B that stores a program (PROG) 10C, and a suitable radio frequency (RF) transceiver 10D for bidirectional wireless communications with the base station 12, which also includes a data processor 12A, a memory 12B that stores a program 12C, and a suitable RF transceiver 12D. The user equipment 10 is coupled to or includes antenna 10E, while the base station 12 is coupled to or includes the antenna 12F. The base station 12 is coupled via a data path 13 to the network controller 14 that also includes a data processor 14A and a memory 14B storing an associated program 14C. The base station 12 also includes one or two antenna outputs 12H, 12J, which can be used to transmit or receive one or two polarizations. It is noted that the data processor 112A and the memory 12B can be included in a controller 12G. Typically, one of the outputs 12H, 12J to two radiating elements (not shown in FIG. 1 but shown in FIGS. 2, 3, 7, and 8) would be used when one polarization is transmitted/received, although two of the outputs 12H, 12J could be used to transmit/receive one polarization over two radiating elements. As another example, two of the outputs 12H, 12J would be used when two polarizations are used, wherein one polarization is communicated using one of the outputs 12H and another polarization is communicated using the other of the outputs 12H, 12J.

The controller 12G may include one or more semiconductor circuits, which can include application-specific integrated circuits and/or discrete hardware in addition to or in place of the data processor 12A and memory 12B. The programs 10C, 12C, and 14C are assumed to include any program instructions that, when executed by the associated data processor, enable the corresponding electronic device to perform operations.

In general, the various embodiments of the user equipment 10 can include, but are not limited to, handsets, cellular telephones, personal digital assistants (PDAs) having wireless communication capabilities, portable computers having wireless communication capabilities, image..capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

In terms of FIG. 1, the antenna embodiments disclosed herein would generally be used as antenna 12F. The antennas disclosed herein can be successfully used, e.g., in base station antennas (AMEST 2005, WP2, T1, ST2) used in cellular wireless networks. However, the antennas may be used in other applications in systems where mutual coupling between radiating elements or transmission lines should be suppressed, and the antennas are therefore not limited to use in base stations of a cellular wireless network. In particular, the user equipment 10 may also use the apparatus for suppression of mutual coupling, such as the antennas, described herein (e.g., as antenna 10E). It is also noted, for instance, that transmission lines create fields (evanescent fields) in their vicinity which are usually not wanted, and these fields can be suppressed by the devices described herein. Typically, however, one does not call these lines “radiators”. Nonetheless, the devices described herein can be used in solving generic electromagnetic compatibility problems because the devices reduce coupling between any two or more current-carrying elements (e.g., of which transmission lines and antennas are then only special cases). Such current-carrying elements could include, as an additional example, chassis of two different devices.

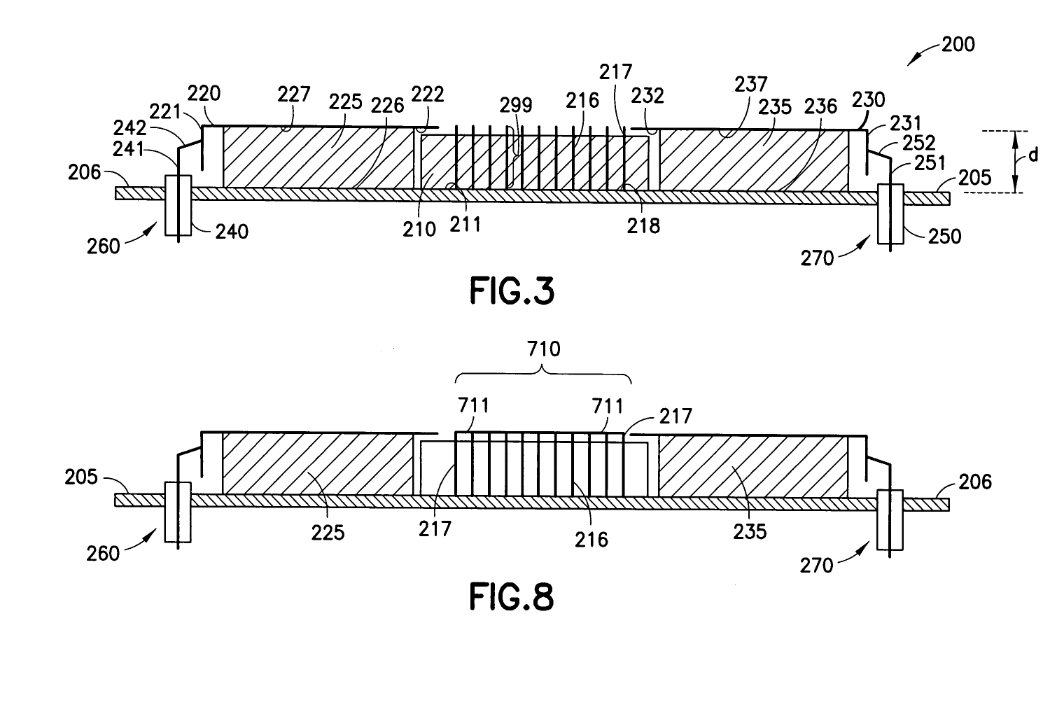

To suppress mutual coupling, a finite-thickness wire medium and associated insulating substrate is placed between radiating elements (or any current-carrying elements, as noted above). Referring now to FIGS. 2 and 3, an antenna 200 is shown that is suitable for use as, e.g., antenna 12F in FIG. 1. FIG. 2 shows a top view of an exemplary antenna 200 having two patch elements 220, 230 and a wire medium 215 placed between the patch elements 220, 230. FIG. 3 is a cross-sectional view shown along cross-section 3-3′ in FIG. 2. Antenna 200 includes a ground plane 205, connectors 260, 270, insulating substrates 225, 235 for patch elements 220, 230 (respectively), an insulating substrate 210 (e.g., a “slab”) into which the wires 216 are placed in a lattice. For clarity, the wires are referred to as pins herein and may be any conductive element. The connectors 260, 270 include ground connectors 240, 250, respectively, that are coupled to the ground plane 205. The connectors 260, 270 also include signal connectors 241, 251, respectively. The connectors 260, 270 may be, e.g., SubMiniature version A (SMA) connectors or other suitable connectors for the frequency range being used in the antenna 200.

Each of the patch elements 220, 230 is a radiating element and has a corresponding connection (e.g., “L”) portion 221, 231, respectively. The connection portion 221, 231 is connected to the signal connectors 241, 251 using conductive couplings 242, 252, respectively. Each of the patch elements 220, 230 is separated from the top surface 206 of the ground plane 205 by a respective one of the insulating substrates 225, 235. The top surfaces 227, 237 of the insulating substrates 225, 235 (respectively) are connected to the bottom surfaces 222, 232 of the patch elements 220, 230 (respectively), typically using glue or other connection methods. The bottom surfaces 226, 236 of the insulating substrates 225, 235 (respectively) are connected to the top surface 206 of the ground plane 205, typically using glue or other connection methods.

Each pin 206 has a top (e.g., “tip”) 217 and a bottom 218. The top 217 is not connected to anything in FIGS. 2 and 3. The bottom 218 is electrically coupled to the ground plane 205 (e.g., to the top surface 206 of the ground plane 205), e.g., galvanically or via capacitance. The patch elements 220, 230 have a flat region 223, 233, respectively, that is placed at a distance d from the top surface 106 of the ground plane 205. In the example of FIG. 2, a distance 282 exists between an edge 283-1 or 283-2 of patch element 220 and edges 284, 285 (respectively) of wire medium 215, and between an edge 283-3 or 283-4 of patch element 220 and edge 284, 285 (respectively) of wire medium 215. It is noted that edge 283-1 of patch element 220 and edge 283-3 of patch element 230 are substantially collinear. Similarly, edge 283-2 of patch element 220 and edge 283-4 of patch element 230 are substantially collinear. Substantial collinear edges typically may be, e.g., five or 10 percent from being perfectly collinear, although perhaps a higher degree of non-collinear edges may be tolerated.

Certain parameters of the antenna 200 (and 700, described below) are the following. Copper wire was used as the pins 216. The copper wire had a diameter 290 of 0.8 mm (millimeter), the spaces 291, 292 between the pins was 5 mm, the distance 294, 295 between an edge 298, 297 of the wire medium 215 and an edge 234, 224 of the patch element 230, 220 is 2.5 mm, the length 299 of pins 216 is the same as the distance d between the patch elements 220, 230 and the top surface 206 of the ground plane 205 (d=20 mm). It is noted that these measurements and materials are merely exemplary, and the cross section of wires can be arbitrary, e.g., they can be made of metal strips. It is noted that the antenna 200 is symmetric around axis 281 and around line 3-3′ (which may also be considered an axis).

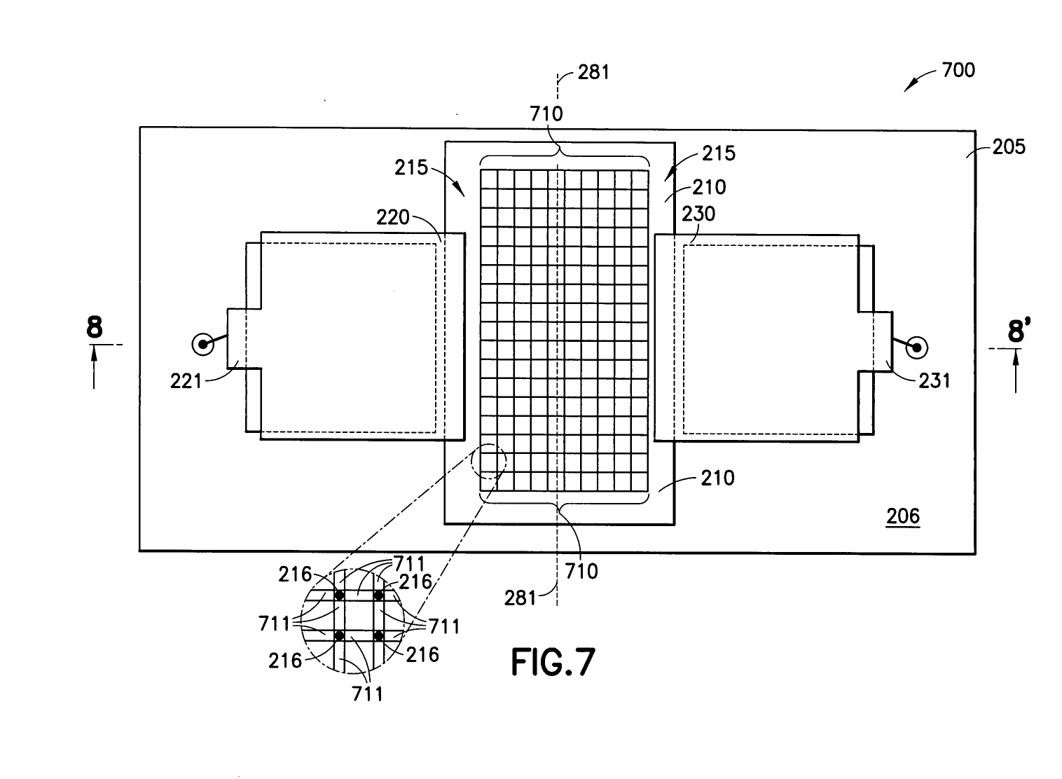

The antenna 200 (arid the antenna 700 shown in FIGS. 7 and 8 and described below) is a special type of an Electromagnetic Band Gap (EBG) structure, exhibiting a stop band at low frequencies. In opposition to other kinds of EBG structures, this band gap can be made very wide because the band gap has a non-resonant nature.

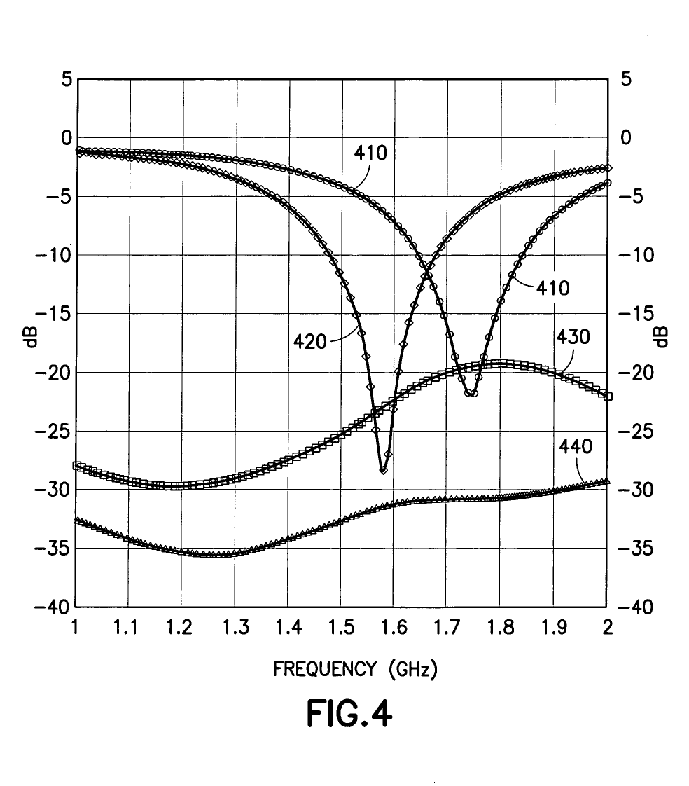

FIG. 4 is a graph of S-parameters of a TM excitation for an antenna with two patch elements 220, 230 and either not having a wire medium placed between the patch elements or having a wire medium placed between the patch elements (as shown in FIGS. 2 and 3). FIG. 4 shows the results of a numerical simulation of S-parameters. A trace 410 of S₁₁ and a trace 430 of S₂₁ are shown for an antenna with two patch elements 220, 230 but without the wire medium 215 and associated insulating substrate 210 shown in FIGS. 2 and 3. A trace 420 of S₁₁, and a trace 440 of S₂₁ are shown for the antenna 200, with two patch elements 220, 230 and with the wire medium 215 and associated insulating substrate 210 shown in FIGS. 2 and 3. Positions of the peaks of S₁₁ in traces 410 (without wire medium 215) and 420 (with wire medium 215) show that the wire medium 215 reduces the resonant frequency of the antenna, indicating an additional advantageous possibility to use the same wire medium 215 also for reducing the size of the antenna. Reduction of mutual coupling of the TM excitation is observed to be about 14 percent at resonant frequencies, as shown by traces 430 (without wire medium 215) and 440 (with wire medium 215).

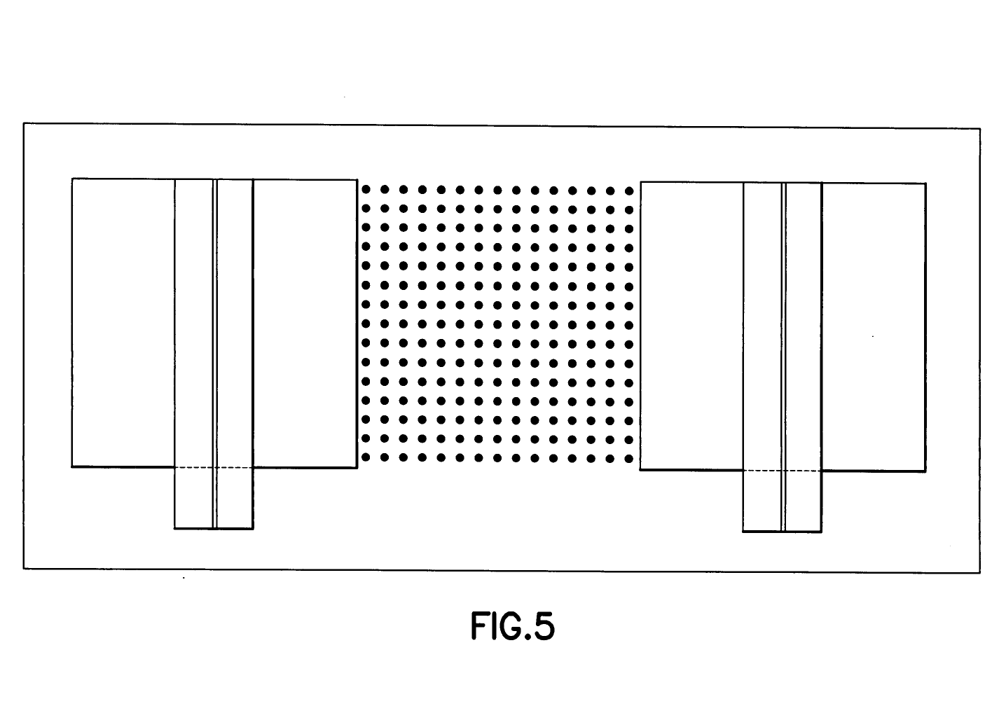

For decoupling of TM-polarized waves, it would be enough to place the wire medium 215 and associated insulating substrate 210 between the patch elements 220, 230. However, simulations and experiments have shown that such a solution increases coupling for TE-polarized waves, which have a non-zero electric vector component parallel to the ground plane, as shown in FIG. 5, an illustration of TE excitation for an antenna 200 with two patch elements 220, 230 and a wire medium 215 (and corresponding insulating substrate 210) placed between the patch elements 220, 230. It is noted that in FIG. 5, the connection (L) portions 221, 231 are in a different location relative to the connection portions 221, 231 shown in FIGS. 2, 3, 7, and 8.

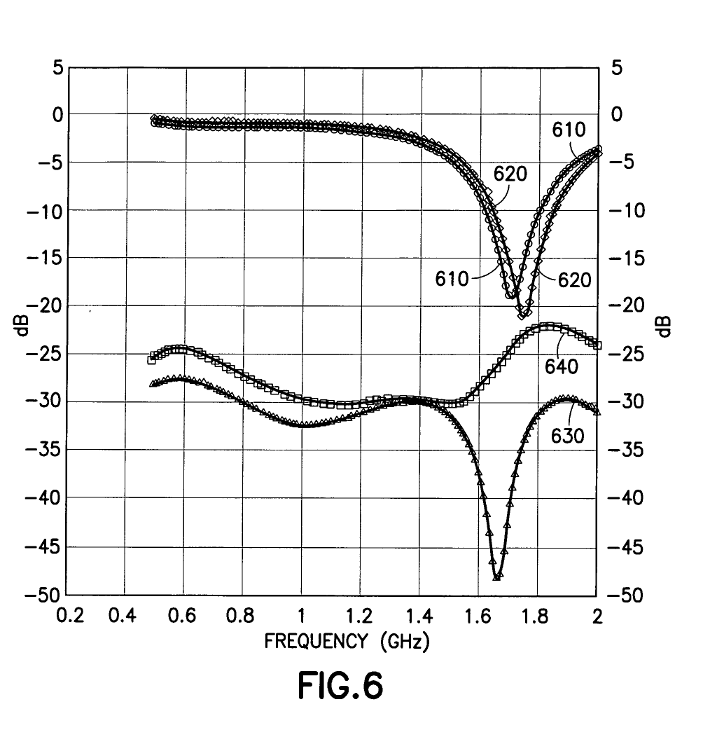

FIG. 6 is a graph of S-parameters of a TE excitation for an antenna with two patch elements 220, 230 and either not having a wire medium 215 placed between the patch elements 220, 230 or having a wire medium 215 (and corresponding insulating substrate 210) placed between the patch elements 220, 230 (as shown in FIGS. 2 and 3). A trace 610 of S₁₁ and a trace 630 of S₂₁ are shown for an antenna with two patch elements 220, 230 but without the wire medium 215 and associated insulating substrate 210 shown in FIGS. 2 and 3. A trace 620 of S₁₁ and a trace 640 of S₂₁ are shown for the antenna 200, with two patch elements 220, 230 and with the wire medium 215 and associated insulating substrate 210 shown in FIGS. 2 and 3. Dramatic increase of the coupling is observed (trace 640 has values greater than does trace 630 at the resonant frequency and higher frequencies), making a wire medium 215 (and associated insulating substrate 210) potentially less suitable for dual-polarized antennas 220.

To suppress TE polarization, it is proposed that the tops (tips) 217 of pins 206 are connected with a conductive mesh 710. FIG. 7 is a top view of an exemplary antenna 700 having two patch elements 220 and 230 and a wire medium 215 with a conductive mesh 710. FIG. 8 is a cross-sectional view shown along cross-section 8-8′ in FIG. 7. The antenna 700 is another antenna suitable for use, e.g., as antenna 12F of FIG. 1. The antenna 700 is the same as antenna 200 of FIGS. 2 and 3, except that conductive mesh 710 has been added. Conductive mesh 710 in this example includes a number of wires 711 that are electrically coupled to the tops 217 of the pins 216. It is noted that the antenna 700 is symmetric about axis 281 and line 8-8′.

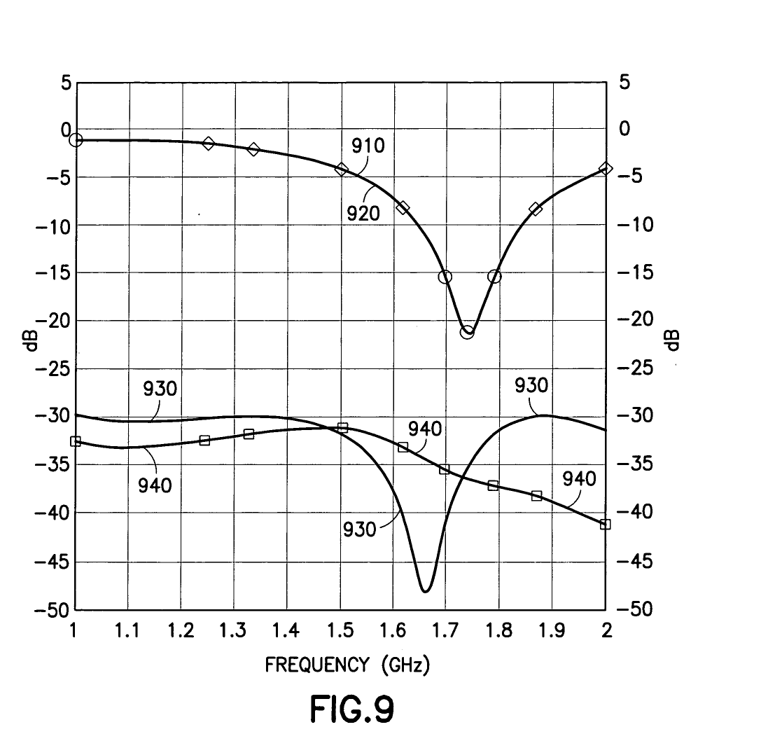

This combination of the conductive mesh 710 and the wire medium 215 improves the characteristics of the decoupling device, as shown in FIG. 9. FIG. 9 is an illustration of S-parameters of a TE excitation for an antenna with two patch elements and either not having a wire medium or having a wire medium and a conductive mesh placed between the patch elements (as shown in FIGS. 7 and 8). A trace 910 of S₁₁ and a trace 930 of S₂₁ are shown for antenna with two patch elements 220, 230 but without the wire medium 215. A trace 920 of S₁₁ (note that traces 910 and 920 are virtually indistinguishable) and a trace 940 of S₂₁ are shown for the antenna 700 of FIGS. 7 and 8. The conductive mesh 710 over and coupled to the wire medium 215 reduces the coupling level to −37 dB, which is even smaller than for the structure without pins for this polarization.

It is noted that the conductive mesh 710 in FIGS. 7 and 8 is shown as having dimensions that are the same dimensions as the wire medium 215. This should yield the best reduction in coupling of TE polarization. However, the dimensions of the conductive mesh 710 could be larger or smaller than the dimensions of the wire medium 215. It is also noted that the wire medium 215 is shown in FIGS. 2, 3, 7, and 8 as being larger along axis 281 than are the patch elements 220, 230. However, the wire medium 215 may also be smaller along axis 281 than the patch elements 220, 230 are along the axis 281. The pins 216 are shown being located at approximately the location where wires 711 meet. However, these locations could be different, e.g., a pin 216 could be located intermediate a location where the wires 711 meet.

One aspect of an exemplary embodiment is that the tops 217 of the pins 216 are connected with a conductive mesh 710 in order to lessen (e.g., forbid) propagation of the surface wave having electric field perpendicular to the pins 216. The new structure of conductive mesh 710 and wire medium 215 offers a solution with extremely attractive characteristics. Exemplary advantages include, but are not limited to, one or more of the following: The antenna 200/700 has a wide stop band due to a non-resonant origin of the effect; and the antenna 200/700 is simplistic compared with other EBG structures; and the antenna 700 provides decoupling of radiating elements for any polarizations in a very wide frequency range, while the antenna 200 provides reduction in TM polarization but may not provide suitable reduction in TE polarization, depending on application.

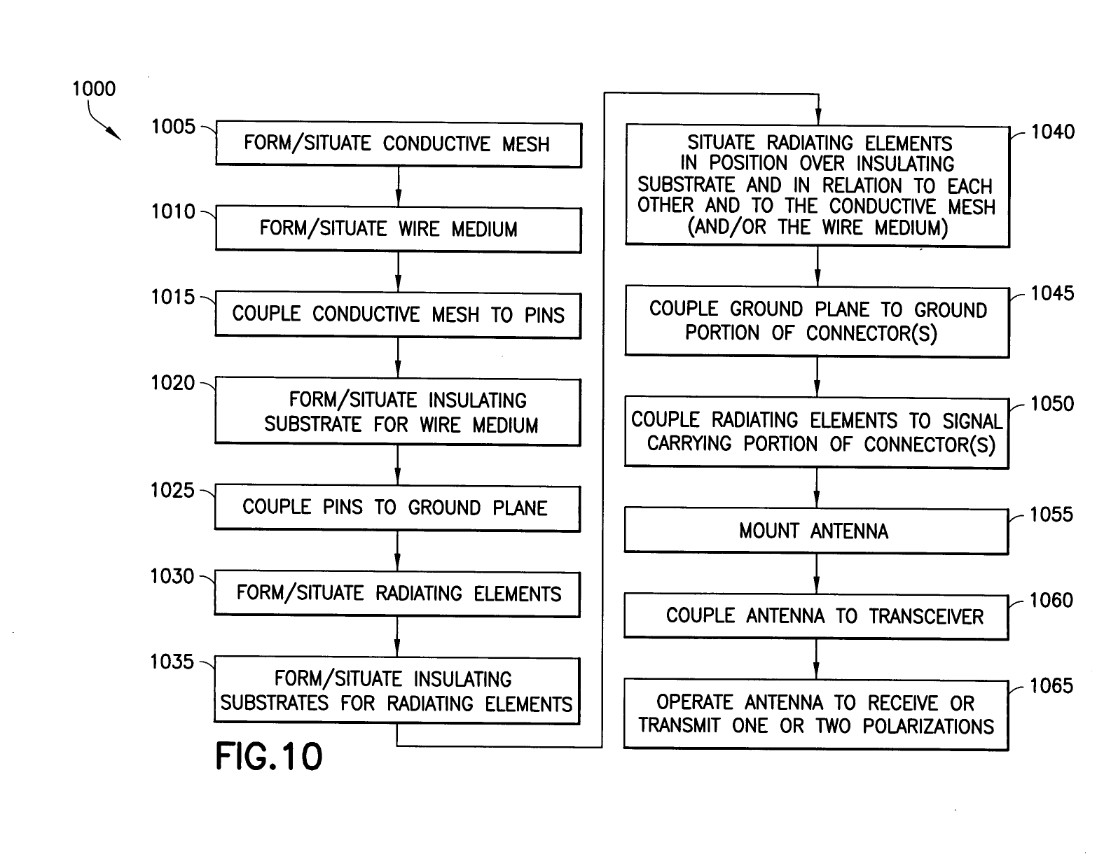

Referring now to FIG. 10, a flowchart is shown of an exemplary method 1000 of making and using the antennas shown in FIGS. 2, 3, 7, and 8. It is noted that the sequence of blocks in method 1000 is merely exemplary and may change depending on implementation. Furthermore, depending on implementation, certain blocks may be performed contemporaneously. It is noted that blocks 1010 and 1020-1065 would be performed in order to make and use antenna 200 of FIGS. 2 and 3. Blocks 1005-1065 would be performed in order to make and use antenna 700 of FIGS. 7 and 8.

Method 1000 begins in block 1005 when the conductive mesh 710 is formed. The conductive mesh can be formed in any number of ways. For instance, conductive wires (e.g., typically copper) could be formed into a grid and soldered together in block 1005 to form the conductive mesh 710. Printed circuit board techniques could be used to form the conductive mesh. In block 1010, the wire medium 215 is formed. In block 1015, the conductive mesh 710 is coupled to the pins of the wire medium 210. In block 1020, the insulating substrate 210 is formed, and in block 1025, the pins 216 of the wire medium 215 are coupled to the ground plane 205.

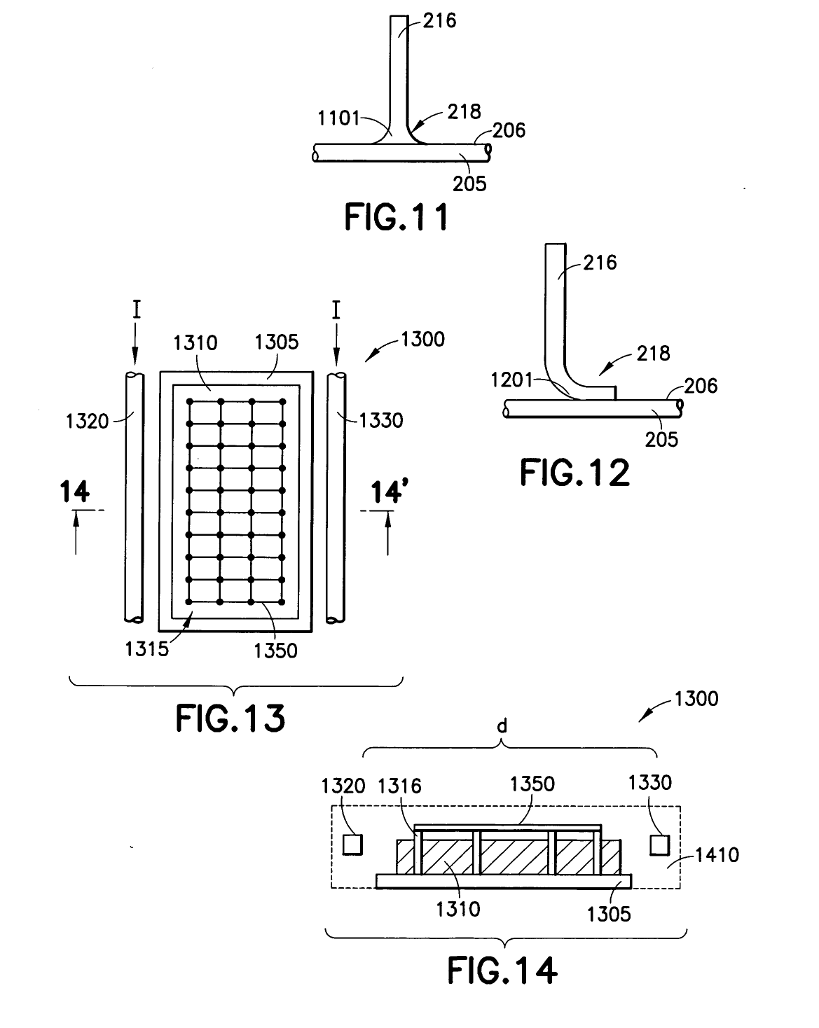

In one example, the wire medium 215 is formed (block 1010) by connecting each pin 216 to the conductive mesh 710, e.g., by soldering or using conductive epoxy. The insulating substrate 210 is formed (block 1020) in the appropriate size, e.g., from polystyrene or other dielectrics such as polytetrafluoroethylene (PTFE) in combination with woven glass, random microfiber glass, and ceramics, and thermoset plastic/ceramic/woven glass. Any insulating substrate may be used. The pins 216 are pushed through the polystyrene and are coupled (block 1025) to the ground plane, e.g., using galvanic action or capacitive coupling. To realize capacitive coupling, the bottom ends of the wires should end with a large enough metal element, positioned near the ground plane, e.g. a metal plate parallel to the ground plane. The ends of the wires would therefore be large enough to create a certain amount of capacitance between the wires and the ground plane. See, for instance, FIG. 11, where pin 216 has a flared portion 1101 at end 218. Additionally, one can bend the wires so that the wires have enough long sections running near (e.g., parallel) to the ground plane. See, e.g., FIG. 12, in which pin 216 has a bent portion 1201 at end 218. In another example, the wire medium 210 is formed by placing pins 216 into the insulating substrate 210 in a lattice (e.g., with equidistant spacing in X and Y directions between pins 216). The pins 216 are then coupled to the ground plane using, e.g., galvanic action or capacitive coupling.

The conductive mesh 710 (if used) is situated (e.g., placed) over the pins 216 and is coupled to the pins 216 using, e.g., conductive adhesives or soldering. As yet another example, the wire medium 215 is formed by attaching the pins 216 in a lattice to the ground plane using such-techniques as soldering, galvanic action, conductive adhesive, etc. The formed insulating substrate 210 is pushed onto the wire medium 215. As an other example, the conductive mesh 1005 could be formed as conductive traces on a printed circuit board. The printed circuit board could have through-holes that mate with pins 216, and the pins 216 would therefore be soldered to the through-holes. As can be seen, there are a number of possible techniques for performing blocks 1005-1025, and not all techniques have been described.

In block 1030, the radiating elements are formed (e.g., patch elements 220, 230). It is noted that the patches 220, 230 are merely exemplary, and many different shapes may be used. The insulating substrates 225, 235 for the radiating elements are formed in block 1035. In block 1040, the radiating elements are situated (e.g., placed) in position over insulating substrates 225, 235 and also in relationship to each other and to the conductive mesh 210. The conductive mesh 710 (and/or the wire medium 215) is positioned between the radiating elements. It is noted that the conductive mesh 710 (and/or wire medium 215) could be formed prior to or after the placement of the radiating elements.

In block 1045, the ground plane 205 is coupled to the ground portion of the connector(s). In the example of FIGS. 2, 3, 7, and 8, there are two connectors 260, 270. However, there could be a single connector. In block 1050, the radiating elements are coupled to the signal carrying portion of the connector(s). In the example of FIGS. 2, 3, 7, and 8, the two connectors 260, 270 have signal connectors 241, 251 that are coupled to the patch elements 220, 230 using a conductive coupling 242, 252. In block 1055, the antenna 200/700 is mounted, such as on a mast. The antenna 200/700 is coupled to a transceiver (e.g., transceiver 12D, although a receiver or transmitter may also be used). In block 1065, the antenna is operated to transmit or receive using one or two polarizations, depending, e.g., on transceiver and antenna configuration.

It is noted that any block of “forming” an element could include situating the element. Illustratively, forming a radiating element (block 1030) could include situating (e.g., placing) the radiating element wherever the element is to be situated. Similarly, blocks 1005, 1010, 1020, and 1035 may also include situating provided parts.

In an exemplary embodiment, the antenna 200/700 might be implemented on a semiconductor, e.g., as antenna 10E of user equipment 10. For instance, the ground plane 205 could be formed on the backside of a semiconductor or as a layer on the semiconductor. The insulating substrates 210, 225, and 235 could be formed using, e.g., deposition and etching. The pins 216 could be formed using techniques used for forming conductive vias. The patch elements 220, 230 could be formed using deposition or other techniques. Exemplary embodiments of the disclosed invention may be implemented on a semiconductor as an element to reduce coupling between any current-carrying elements (e.g., transmission lines), not necessarily between patch elements of antennas. Typically, the sizes of patch antennas are larger than the size of a semiconductor, and therefore semiconductor techniques are generally not used for patch antennas. Nonetheless, scaling of the antennas 200/700 may be performed to enable use of antennas 200/700 on a semiconductor. Further, as described above, certain embodiments of the disclosed invention may be used to reduce coupling between any current-carrying elements formed on or not formed on semiconductors. For instance, certain user equipment 10 might have multiple antennas, possibly formed on a semiconductor or not formed thereon, and the use of a wire medium (e.g., in conjunction with the wire mesh) may be used to reduce coupling between the antennas. Consequently, a user equipment 10 formed, e.g., using a handset, could contain and use one or more wire media (and, if desired, corresponding wire mesh) in order to reduce coupling between or in antennas and other current carrying elements.

An example is shown in FIGS. 13 and 14, where electrically conductive (e.g., current-carrying) elements 1320, 1330 of apparatus 1300 are separated by a distance, d. These electrically conductive elements 1320, 1330 could form, e.g., one or more transmission lines or be chassis of two different devices. In this example, a ground plane 1305 is placed between the electrically conductive elements 1320, 1330. An insulator (e.g., dielectric) 1310 is coupled to the ground plane 1305, and a wire medium 1315 comprising pins (also called wires) 1316 is formed in the insulator 1310. A conductive mesh 1350 is also formed and is coupled to the wire medium 1315. The ground plane 1305 could extend under (e.g., and under and past) the electrically conductive elements 1320, 1330, if desired. The apparatus 1300 may be formed in a semiconductor 1410, e.g., as part of one or more integrated circuits. It is noted that the wire media shown in FIGS. 13-14 may be used without the conductive mesh.

The foregoing description has provided by way of exemplary and non-limiting examples a full and informative description of the best techniques presently contemplated by the inventors for carrying out embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the scope of this invention.

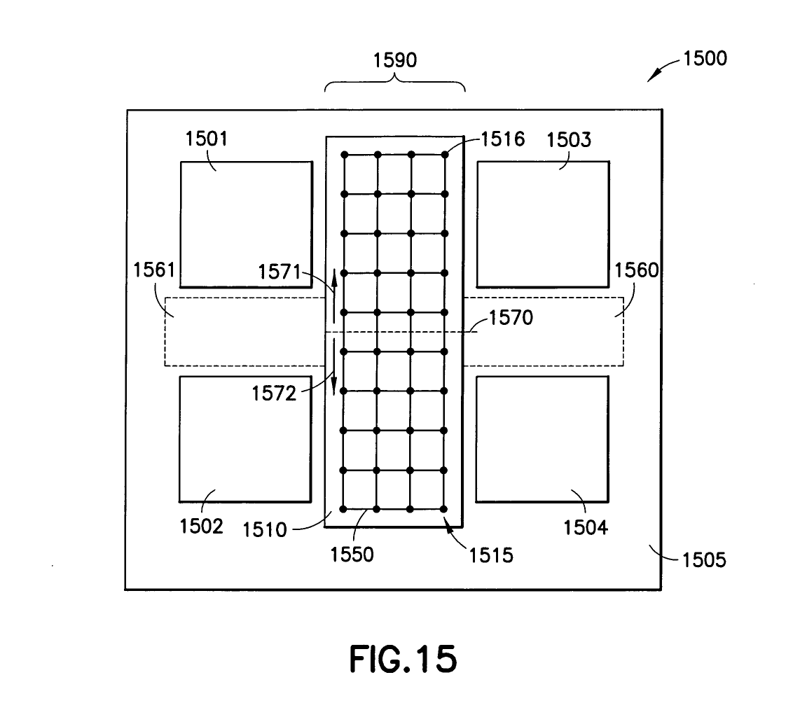

For instance, although only two current-carrying (e.g., radiating elements or transmission lines) were shown above, the disclosed invention is applicable to multiple such elements. For instance, shown in FIG. 15 is an antenna 1500 having a ground plane 1505 and multiple patch elements 1501, 1502, 1503, and 1504. In between a set of patch elements 1501, 1502 and a set of patch elements 1503, 1504 is an insulator 1510, a wire medium 1515 having pins 1516 and a conductive mesh 1550. The insulator 1510 and a wire medium 1515 having pins 1516 (and conductive mesh 1550, if used) comprise a decoupling device 1590. The decoupling device 1590 may also be extended (e.g., as a single entity) into areas 1561, 1560. In the example of FIG. 15, the radiating elements 1501, 1502 are operated with one polarization and the radiating elements 1503, 1504 are operated with another polarization. As another exemplary embodiment, there could be one decoupling device 1590 for each set of patch elements. For instance, one decoupling device 1590 (the portion 1571 “above” line 1570, where the portion 1571 of the decoupling device 1590 above line 1570 is decoupled from the portion 1572 of the decoupling device 1590 below line 1570) would be placed between the set of patch elements 1501, 1503; a second decoupling device 1590 would be placed in area (e.g., space) 1560 between the set of patch elements 1503, 1504; a third decoupling device 1590 (the portion 1572 “below” line 1570) would be placed between the set of patch elements 1504, 1502; and a fourth decoupling device 1590 would be placed in the area (e.g., space) 1561 between the set of patch elements 1502, 1501. In the antenna 1500, there could be anywhere between one and four connectors (not shown in FIG. 15), depending on configuration. It is noted that the wire media shown in FIG. 15 may be used without the conductive mesh.

Furthermore, some of the features of exemplary embodiments of this invention could be used to advantage without the corresponding use of other features. As such, the foregoing description should be considered as merely illustrative of the principles of embodiments of the present invention, and not in limitation thereof.

What is claimed is:

1. An apparatus, comprising:
a plurality of electrically conductive spaced apart elements;
a ground plane situated at least partially in a space between at least two of the electrically conductive spaced apart elements; and
at least one wire medium situated over at least a portion of the ground plane and coupled to the ground plane, the at least one wire medium situated at least partially in the space between the at least two electrically conductive spaced apart elements.

2. The apparatus of claim 1, wherein each of the plurality of electrically conductive spaced apart elements comprises one of a radiating element, a transmission line, or a chassis of a device.

3. The apparatus of claim 1, wherein the apparatus is an antenna, wherein each of the plurality of electrically conductive spaced apart elements comprises a radiating element, and wherein each of the plurality of radiating elements has a portion that is approximately parallel to and situated above the ground plane.

4. The apparatus of claim 3, wherein the at least one wire medium resides at least partially in spaces separating at least three of the radiating elements.

5. The apparatus of claim 3, wherein the at least one wire medium comprises a plurality of wire media.

6. The apparatus of claim 5, wherein each wire medium is situated at least partially in a space between each set of two radiating elements.

7. The apparatus of claim 3, further comprising a conductive mesh coupled to at least a portion of the wire medium and situated at least partially in the space between the at least two radiating elements.

8. The apparatus of claim 7, wherein the plurality of radiating elements are first and second radiating elements, wherein first and second radiating elements, the wire medium, and the conductive mesh have widths along a first axis, wherein the apparatus is symmetric about the first axis, wherein the first and second radiating elements, the wire medium, and the conductive mesh have lengths along a second axis, and wherein the apparatus is symmetric about the second axis.

9. The apparatus of claim 7, wherein the plurality of radiating elements are first and second radiating elements, wherein the conductive mesh has a width along a first axis and a length along a second axis, the wire medium has a width along the first axis and a length along the second axis, the width of the conductive mesh is approximately the width of the wire medium, and the length of the conductive mesh is approximately the length of the wire medium.

10. The apparatus of claim 7, wherein:
the wire medium comprises a plurality of pins formed into a lattice;
the conductive mesh comprises conductive wires configured such that intersections of the conductive wires occur approximately at pin locations; and
the conductive wires are coupled to the pins.

11. The apparatus of claim 1, further comprising an insulating substrate in which the wire medium resides.

12. The apparatus of claim 11, wherein the insulating substrate comprises a dielectric.

13. The apparatus of claim 3, further comprising a plurality of insulating substrates, each of the insulating substrates corresponding to one of the radiating elements, and wherein each of the insulating substrate occupies a space between a corresponding radiating element and the ground plane.

14. The apparatus of claim 13, wherein the insulating substrate comprises a dielectric.

15. The apparatus of claim 1, wherein the apparatus is formed at least in part on a semiconductor.

16. The apparatus of claim 3, wherein the plurality of radiating elements are first and second radiating elements, and wherein the apparatus comprises a first connector having a signal portion coupled to the first radiating element and a ground portion coupled to the ground plane and a second connector having a signal portion coupled to the second radiating element and a ground portion coupled to the ground plane.

17. The apparatus of claim 3, wherein the plurality of radiating elements are first and second radiating elements, wherein each of the first and second radiating elements is formed substantially as a rectangle, wherein each of the rectangles comprises edges separated by the space, and wherein the edges are substantially parallel.

18. The apparatus of claim 17, wherein a length of the wire medium along a first axis parallel to the edges is larger than lengths along the first axis of the rectangles of the first and second radiating elements, and wherein a center of the wire medium along a second axis perpendicular to the first axis is approximately collinear with an axis that intersects middles of the rectangles of the first and second radiating elements.

19. An apparatus, comprising:
an antenna comprising:
a ground plane;
a plurality of spaced apart radiating elements, each of the plurality of radiating elements having a portion that is approximately parallel to and situated above the ground plane;
at least one connector having a ground portion coupled to the ground plane and a signal portion coupled to the plurality of radiating elements; and
at least one wire medium situated over and coupled to the ground plane, the at least one wire medium situated at least partially in a space between at least two of the radiating elements; and
a transceiver coupled to the at least one connector and configured to transmit or receive using the antenna.

20. The apparatus of claim 19, wherein:
the plurality of spaced apart radiating elements include first and second radiating elements;
the at least one connector further comprises a first connector having a signal portion coupled to the first radiating element and a second connector having a signal portion coupled to the second radiating element; and
the transceiver is configured to transmit or receive two polarizations, a first polarization corresponding to the first radiating element and the first connector, and a second polarization corresponding to the second radiating element and the second connector.

21. The apparatus of claim 19, wherein the apparatus comprises a user equipment.

22. The apparatus of claim 21, wherein the user equipment comprises one of the following: a handset; a cellular telephone; a personal digital assistant; a portable computer; an image capture device; a gaming device; a music storage and playback appliance; or an Internet appliance.

23. The apparatus of claim 19, wherein the apparatus comprises a base station configured for cellular telephone communications.

24. The apparatus of claim 19, wherein the apparatus is formed at least in part on a semiconductor.

25. An antenna, comprising:
a ground plane;
a first patch element having an edge and comprising a portion that is approximately parallel to the ground plane;
a first insulating substrate positioned between the portion of the first radiating element and the ground plane;
a second patch element having an edge and comprising a portion that is approximately parallel to the ground plane, wherein the first and second patch elements are separated by an area and the area is partially bounded by the edges of the first and second patch elements;
a second insulating substrate positioned between the portion of the second radiating element and the ground plane;
at least one connector having a ground portion coupled to the ground plane and a signal portion coupled to the first and second radiating elements;
a wire medium coupled to the ground plane and formed in a third insulating substrate, the third insulating substrate and wire medium situated at least partially in the area between the edges of the first and second patch elements; and
a conductive mesh coupled to at least a portion of the wire medium and situated at least partially in the area between the edges of the first and second patch elements.

26. The antenna of claim 25, wherein the conductive mesh has a width along a first axis and a length along a second axis, the wire medium has a width along the first axis and a length along the second axis, the width of the conductive mesh is approximately the width of the wire medium, and the length of the conductive mesh is approximately the length of the wire medium.

27. The antenna of claim 25, wherein the antenna is formed at least in part on a semiconductor.

28. A method, comprising:
spacing apart a plurality of elements, each of the elements configured to carry current;
situating a ground plane at least partially in a space between at least two of the spaced apart elements;
situating at least one wire medium over at least a portion of the ground plane, the at least one wire medium situated at least partially in the space between the at least two spaced apart elements; and
coupling the at least one wire medium to the ground plane.

29. The method of claim 28, wherein:
spacing apart a plurality of elements further comprises forming the plurality of elements;
situating a ground plane further comprises forming a ground plane at least partially in the space between the at least two spaced apart elements; and
situating at least one wire medium further comprises forming the at least one wire medium over the portion of the ground plane.

30. The method of claim 29, wherein forming the at least one wire medium and coupling the at least one wire medium to the ground plane are performed contemporaneously.

31. The method of claim 28, wherein:
the elements include first and second radiating elements, each of the first and second radiating elements having a portion;
spacing apart a plurality of elements further comprises situating the portions of the first and second radiating elements approximately parallel to and situated over the ground plane;
situating a wire medium further comprises situating the wire medium to reside at least partially in the space between the first and second radiating elements; and
the method further includes coupling a ground portion of at least one connector to the ground plane and coupling a signal portion of at least one connector to the first and second radiating elements.

32. The method of claim 28, wherein the at least one wire medium further comprises a plurality of pins in a lattice, and wherein coupling the at least one wire medium to the ground plane further comprises comprising coupling the pins to the ground plane through at least one of galvanic action, conductive adhesives, or capacitive coupling.

33. The method of claim 28, further comprising forming a conductive mesh coupled to at least a portion of the wire medium and situated at least partially in the space between the at least two spaced apart radiating elements.
